(19) United States
(12) Patent Application Publication
(10) Pub. No.: US 2006/0143442 A1
(43) Pub. Date: Jun. 29, 2006

(54) Automated issuance of SSL certificates

(76) Inventor: Sander A. Smith, Toronto (CA)

Correspondence Address: INTEGRAL INTELLECTUAL PROPERTY INC., 44 LONGWOOD DRIVE, TORONTO, ON, M3B 1T8, CA

(21) Appl. No.: 11/312,509

(22) Filed: Dec. 21, 2005

Related U.S. Application Data
(60) Provisional application No. 60/639,790, filed on Dec. 24, 2004.

(51) Int. Cl. H04L 9/00

(52) U.S. Cl. 713/156

(57) ABSTRACT

A system and process unifies DNS/Naming registration, trusted SSL certificate generation and signing. While installing a product, a customer registers it. This automatically enables the customer to use the DNS/Naming registration service offered by the entity, which automatically assigns a customer specified symbolic name for the product so that it can easily be found on the Internet. This is done simply and inexpensively by piggybacking on one of the domains owned by the entity. Once this happens, a SSL certificate is created and signed based on the subdomain. No verification of the SSL certificate is required, since the subdomain was assigned by the entity and it knows to whom it was assigned.

### CROSS-REFERENCE TO RELATED APPLICATIONS

This application claims the benefit under 35 USC 119(e) of U.S. Provisional Application No. 60/639,790, filed Dec. 24, 2004, which is incorporated herein by reference.

### BACKGROUND

As consumer computing devices evolve, more and more of them will be equipped with remote access servers that connect to networks such as the Internet, and allow access to the data that they manage. Such servers may include, web servers, file sharing systems, remote computer control applications such as PcAnywhere from Symantec Corporation, Internet hardware devices, Network Attached Storage (NAS) devices, Internet-connected utility meters, cell phones and personal computing devices (PDAs).

An issue of concern is security for the data accessed from these consumer computing devices. Security is well established on e-commerce web sites through the use of Secure Socket Layer (SSL). SSL uses trusted certificates that are issued and managed by a Certificate Authority (CA). Examples of CA's include VeriSign Inc. of Mountain View Calif., GeoTrust Inc. of Needham Mass. and Comodo Group Inc. of Jersey City, N.J.

For a typical consumer, trusted SSL certificates are difficult to deploy and configure. Further, the cost of obtaining a trusted SSL certificate may be prohibitive for a consumer computing device.

### SUMMARY

Embodiments of the present invention address the need for a simple and cost effective setup to provide a trusted SSL certificate for a consumer computing device.

One embodiment of the present invention is directed to a system for the automated issuance of a SSL certificate, the system comprising: a first product operatively connected to a product registration agent; a certificate provisioning server operatively connected to the product registration agent under control of an entity; and the certificate provisioning server operatively connected to a certificate authority and a domain name server.

Another embodiment of the present invention is directed to a method for the automated issuance of a SSL certificate, the method comprising the steps of: installing a first product; invoking a product registration agent to generate a CSR, the DNS name within the CSR being known to the product registration agent; forwarding the CSR to a certificate authority for issuance of the SSL certificate; and returning the SSL certificate to said first product to permit secure communication between said first product and a client.

### BRIEF DESCRIPTION OF THE DRAWINGS

For a better understanding of the present invention, and to show more clearly how it may be carried into effect, reference will now be made, by way of example, to the accompanying drawings which aid in understanding an embodiment of the present invention and in which:

FIG. 1 is a block diagram illustrating a man in the middle attack;

FIG. 2 is a block diagram of a system utilizing an embodiment of the present invention;

FIG. 3 is a block diagram illustrating the logical interaction between the modules of the system of FIG. 2;

FIG. 4 is a block diagram illustrating the steps in connecting a client and a product;

FIG. 5 is a block diagram illustrating a process of connecting a client and a product through a gateway;

FIG. 6 is a block diagram illustrating a process of connecting a client and a product through redirection;

FIG. 7 is a block diagram illustrating a process of connecting a client and a product through predictive demultiplexing; and

FIG. 8 is a block diagram illustrating the steps in revoking a certificate.

### DETAILED DESCRIPTION OF EMBODIMENTS OF THE INVENTION

Privacy is a primary concern when sharing personal information on a network such as the Internet. For example, when family pictures are posted on the Internet, it is usually easy to obtain information about the people in the pictures. Quite often pictures are annotated with names or addresses. In addition a picture showing a house number, a school name or license plate numbers makes the task of determining the individuals in the picture even easier.

Any data transmitted between any two computers on the Internet is vulnerable to a sniffing attack. This means that anyone between those computers can observe the data that flows between them and reconstruct the information that is sent.

For users that are concerned about privacy, there are proven methods to ensure that information transmitted between a remote access server and another party is kept secret. Such methods are used by online banking services and corporations to ensure confidential access of information.

The solution to the remote access server privacy problem is the same as the solution to the e-commerce problem. The solution to the e-commerce problem is the Secure Sockets Layer (SSL) protocol. SSL has been adopted by the Internet Engineering Task Force (IETF) as RFC 2246, and renamed Transport Layer Security (TLS). SSL includes two methods for ensuring consumer confidence when performing e-commerce transactions: encryption and authentication. We will refer to other documents by RFC number in this disclosure, each number refers to an RFC published by the IETF.
1) Encryption. The transmission of data should be secure so that no one can sniff the data that is sent. Public Key Cryptography (PKC) is a method that secures data transmission so that if data is sniffed it cannot be understood. PKC relies on an entity creating two keys that are used to encrypt information. One key is kept secret (the private key) while the other is made public (the public key). To send a secured message to an entity, a user encrypts the message using standard methods and that entity's public key. Once encrypted, the only way to decrypt the message is to use the private key. This means that the only one who can understand the message is the one with the private key. This is the basis for keeping SSL transmissions private. While encryption itself is a powerful tool, on its own, it is insufficient to give consumers the confidence they need when performing e-commerce transactions.
2) Authentication. The user should be confident that data received was really sent by the correct web site. This prevents a man in the middle (MITM) attack, in which a hacker sits between a user and a legitimate web server, while posing as the legitimate web site. In reality, the user is connected to the hacker's site which may be creating fictitious data, modifying the user's inputs, or even silently reading the traffic going between the user and the web site.

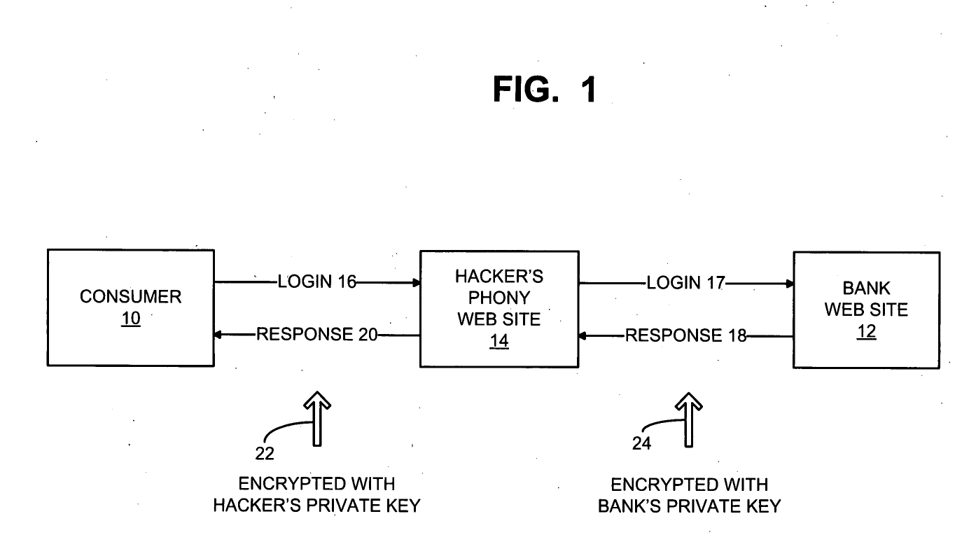

To understand how a MITM attack works we refer now to FIG. 1 which is a block diagram illustrating an MITM attack. On the Internet, any data passed between two computers is on a public network, and anyone with the desire and knowledge can read it. A MITM attack occurs when a hacker positions himself between a consumer and a resource that that consumer wants to use. For instance, a consumer 10 who wants to connect to a bank to conduct a transaction can access the bank's web site 12 and type in login account information 16. The hacker can then intercept through a phony web site 14 the information and pass it on to the real bank web site 12 via login 17, thereby impersonating the consumer. Whatever data 18 is returned by bank web site 12 is then forwarded (and perhaps modified) as a response 20, by the hacker's phony web site 14 to the consumer 10. In this way, the consumer 10 is unaware that anything wrong is going on, and in fact, may even be communicating with the hacker in an encrypted manner as shown in features 22 and 24. The hacker can see all transactions, and may be able to modify them for personal advantage.

Of course, if this could really happen, no one would be willing to do banking over the Internet. Internet banking is viable because not only is encryption used, but a consumer can also authenticate the web site with which they have an encrypted session, i.e. they can verify that the web site is the one wanted and not an imposter who has launched an MITM attack.

A web site is generally authenticated by an X.509 certificate in the form of an SSL certificate. X.509 is a standard created by the International Telecommunication Union (ITU) and formalized by the IETF as RFC 2459. An X.509 certificate contains information about the entity that owns it and binds it to that entity's public key. There is also data from a well-trusted third party confirming that all the information inside the certificate has been verified as true.

The way that certificates are created, signed, and installed depends on the company from which a certificate is acquired and the web server in which it is installed. When a company wants to create a certificate, it follows the procedure below, with which all CAs and tools are compatible.
1) The company uses a standard tool such as OpenSSL or Java's KeyTool to create a public and private key. This tool also inserts the public key and the company's identifying information into a certificate. The information about the keys and certificates is now in a file on the company's computer. It should be safeguarded, since anyone who possesses the private key may listen in on any SSL transaction that uses it. Hardware devices that safeguard the security of these keys are available.
2) The company uses the same tool to create a standardized Public Key Cryptography Standard (PKCS) Certification Signing Request (CSR). This request is referred to in the PKCS standard as PKCS#10, and documented in RFC 2986. This CSR looks like a long string of text, and contains information about the public key as well as the company's identifying information.
3) The company sends the CSR to a CA (usually through e-mail) along with any other documentation that is necessary to process the request.
4) The CA vets the certificate by verifying that:
   a) The CSR represents a legitimate certificate.
   b) The company submitting the request legally controls the domain it represents.
   c) Some CAs may even vet the validity of the business itself.
5) If the vetting is successful, the CA signs the request, and creates a Formatted Certificate Chain (FCC) that represents the entire chain of certificates necessary to form a chain of trust from the CA's root certificate to the company's certificate. The FCC is referred to in the PKCS standard as PKCS#7, and documented as RFC 2315.
6) The CA returns this FCC to the company.
7) The company installs the FCC on the web server that will use it with the process specified by that web server.

The web sites of CAs include complex instructions for implementing this procedure. The instructions are so complex that even seasoned computer professionals can be intimidated by them. For a casual computer user who simply wants to share personal data, such as pictures online, following these instructions is very difficult.

Since X.509 is an open standard, there are tools to create certificates containing any information desired. For example, it is relatively easy to create a certificate that claims to belong to mycompany.com and attempt to fool people with it (we assume that the person trying to do this has no relationship with mycompany.com). However, since a CA relies on public trust, it will not put its reputation on the line by signing a certificate unless it is sure of its validity. This means that if a certificate is created specifying mycompany.com as the owner and presented to a recognized CA for signing, it will be rejected unless the submitter can prove they have the authority to conduct business as mycompany.com.

Of course, this simply moves the problem up one level. In the same way that one can deviously create a phony mycompany.com certificate, they could also create a phony VeriSign certificate and use it to sign the phony mycompany.com certificate. This would allow the launch of a MITM attack. Fortunately, this deception is easy to detect.

To understand how to detect this scam, it is important to consider how it plays out. When a user accesses mycompany.com through a web browser, and is ready to pay for their purchase with a credit card, mycompany.com attempts to use SSL to secure the transaction. The mycompany.com server transmits its certificate to the browser, and if the certificate is trustworthy, the server switches to SSL mode and starts secured transmission. To determine if a certificate is trustworthy a browser first checks that the certificate is valid and is properly signed. If so, it checks that the issuer is trustworthy. It can do that because each browser (e.g. Microsoft Internet Explorer or Firefox) has certificates from all known trustworthy CAs built into the browser. If the issuer of the certificate is not known to the browser, then a message box pops up warning the user that the certificate may not be valid. Thus, one could create a phony VeriSign certificate, but without VeriSign's private key (a closely guarded secret) the browser will not be fooled into thinking that the certificate is from the real VeriSign. This is the real protection against a MITM attack.

Inside an X.509 certificate there are fields containing data that make up the certificate. To understand how a certificate works, we will discuss several of these fields.

The subject field identifies the certificate owner. It contains information such as the name of the entity, the organization that it belongs to, and the geographical location in which it is located. For purposes of SSL, the subject's common name is normally set to the domain name of the web site that this certificate is associated with. For instance, if mycompany.com wanted to enable SSL transactions for its main web server, it would have a certificate whose subject's common name was www.mycompany.com. Subject common name is not always the place in which a web site's URL may be found. Other places may include the DNSName certificate extension

The issuer field contains information about the entity that signed the certificate. It includes the same types of information as the subject field.

The public key field contains the public key of the owner of this certificate. It is with this key that others may securely encrypt data and send it knowing that the owner is the only one who may successfully decrypt it.

The validity field contains the time period during which the certificate is valid.

Certificates are sometimes problematic. For example:
a) The certificate was wrongly issued (because of information that was not known during the vetting process) or;
b) The certificate has become compromised for some reason (such as someone stealing the private key).
In these cases, the certificate should be revoked. If the end of the certificate's valid period is far in the future, this need becomes critical.

Revoking a certificate is difficult, since during a SSL session, the decision to start secure transmission is based on the data the server presents to the browser. The CA is not normally a party to this transaction, and it cannot change a certificate after signing it and transferring it back to its owner. The browser could check with the CA that each certificate it signs is valid each time it is accessed, although this defeats the purpose of embedding CA certificates into the browser and is very inefficient. There are two popular methods of invalidating a signed certificate, which are described below.

The most common method for revoking a certificate is through a Certificate Revocation List (CRL), documented in RFC 3280. This is a list that a CA creates listing all the certificates it has signed that it now wants to revoke. This list is made available to all browsers, and can be automatically downloaded from the CA's web site. In theory, browsers download and check a CA's CRL before trusting a certificate presented to it. In practice, this does not always happen properly. There are two problems with CRLs:
1) Downloading a long list of revoked certificates from a web site is a slow process. This ultimately slows the web browsing experience; and
2) CAs only issue CRLs periodically. If a CA wants to revoke a certain certificate but the next CRL update is scheduled in another two weeks, this leaves a two-week window during which a bad certificate is still seen by browsers as trustworthy.
In reality, CRL usage is spotty at best, and many browsers do not properly implement this functionality due to the inherent problems. This creates vulnerability for all SSL users.

Another way to revoke a certificate is through Online Certification Status Protocol (OCSP), documented in RFC 2560. This is a protocol in which the browser really does communicate with a server in real time to determine if a certificate is still trustworthy and not revoked. It is easy to see that this process is very time consuming. In addition, it places a burden on the CA's servers.

As described above, SSL begins to work when a user connects to a server in which SSL is enabled. Before any secure data passes between them, the server sends its certificate to the browser for inspection. When the browser receives this certificate, it performs the following checks to verify its validity:
1) The server certificate contains valid dates.
2) The server certificate is properly signed by the issuer.
3) The issuer is known to be trustworthy by the browser.
4) No certificates in the chain have been revoked (by looking at either CRL or OCSP).
5) The name on the server certificate exactly matches the hostname of the web site to which the user is connected.

If all these checks are positive, then the browser can use the public key in the certificate to begin encrypted communication with the server. This means that SSL is being used, and the familiar padlock icon closes at the bottom of the browser window to inform the user that any communication is now secure. The padlock icon indicates that transmission is encrypted so that no one can sniff it, and that the browser is really connected to the server listed in the browser's address bar, and no hacker is pretending to be the server.

Sometimes when a browser inspects a server certificate, one of the checks fails. Common failures include:
a) Invalid dates. If the current date is outside the range of the valid dates in the certificate, then this check fails. This does not necessarily indicate an imposter certificate. It may be caused by an incorrectly set clock on the user's computer. Alternatively, the web site may have neglected to renew its certificate with the CA.
b) Unknown Issuer. If a browser encounters a CA certificate it does not recognize, then this check fails. This may indicate a dangerous situation, e.g. someone “posing” as a known web site. Alternatively, the browser may be an old version, which does not have a known and trustworthy CA certificate built in, because it was issued after the browser was shipped.

When a failure occurs, the browser displays the relevant information to the user and enables the user to decide whether or not to proceed with the transaction.

Since SSL is generally a feature of e-commerce sites, which can afford to hire skilled professionals to configure and maintain its computers, installing certificates and configuring them is complex. In contrast, someone who simply wants to run a personal web site for family pictures is probably not an expert in many of the technologies required to configure SSL. Even worse, if this amateur implements SSL incorrectly, the site may become unsecured and enable hackers to infiltrate.

We will now briefly discuss the concept of the Domain Name System (DNS), documented in RFC 1034 and RFC 1035. The Internet Protocol (IP) defines a unique address for all computers on the Internet. This address in general has the format a.b.c.d, where each letter represents a number between 0 and 255. Since these strings of numbers are difficult for people to remember, the Domain Name System (DNS) was created. DNS allows Internet addresses to be referenced by easier to remember and familiar domain names (such as mycompany.com). DNS provides a mechanism for resolving domain names into their host addresses so that they are useful.

In order to effectively use DNS, one must first own the rights to the domain they want to use. It is simple to register a domain name with one of many domain registration companies. Once the rights to a domain name are owned, for example, mycompany.com, this name can then be bound to a web server's IP address through a DNS server: Once this is done, everyone can refer to the web server by its domain name, mycompany.com, rather than by its host IP address.

A very powerful feature of DNS is that once a domain name is registered, all its possible subdomains are also under control of the owner, without requiring additional permission. A subdomain of a domain is simply a name prepended to the domain name and separated with a period. For example, instead of accessing the web site through mycompany.com, most companies would rather that it be done through the more typically named www.mycompany.com. It is also possible to create another web server, pictures.mycompany.com, in addition to www.mycompany.com. It is easy to register the name pictures.mycompany.com with the DNS server that controls the domain.

Because there are only a limited number of IP addresses available for the entire Internet community (a very large number, but there is still a limit), many Internet Service Providers (ISPs) attempt to optimize their network by dynamically allocating their IP address to their customers instead of assigning them a fixed address. In practice, most people are not even aware that this is happening, and they really have no reason to care. However, for people who want to run a server from home, having a dynamic IP address can be an issue. The server should have a name assigned to it so that it can be easily found. Then, an agent must run alongside the server and alert the DNS server in charge of the resolution of any changes to the IP address. In this way, visitors can always find the server, even if the IP address changes dynamically. This demand for dynamic DNS resolution has led to the creation of several related services on the Internet. Companies such as Dynamic Network Services Inc. of Manchester, N.H., enable a user to create a subdomain from domains they own. This allows users to create subdomains for their remote access servers without the cost of registering their own domain.

By way of an overview of embodiments of the present invention, privacy is provided to remote access servers using SSL. This can be accomplished in a cost-effective manner by merging the product registration, DNS/Naming registration, and SSL certificate generation and signing procedures into a unified operation during product installation. This simple process for the casual user achieves true security and privacy that can be monitored and verified. Certificates can be signed immediately, without requiring a vetting process. Vetting is unnecessary because a single entity is responsible for the entire process, for instance, the company that is responsible for both the product that will be SSL-enabled as well as the base domain that will be used to create the name that is used to find an instance of this product. When this entity must verify that a CSR it receives is valid, no checking is necessary because agents of that entity were responsible for creating all of the parts of the CSR. Certificates can be revoked immediately, without reliance on CRLs, OCSP, or any other ineffective method. DNS services, or any other method for finding a running product, can be denied, which effectively makes the problematic certificate unusable.

In one embodiment all servers are operated by a company or a third party and connected to the Internet. They use a secured Internet connection to process requests made to them by means of a Web Services interface, such as Simple Object Access Protocol (SOAP) or another similar mechanism. If desired, some of these servers may be aggregated together if they are to run on the same computer system.

Some embodiments of the present invention integrate the processes of product registration, DNS/Naming registration, and certificate generation and signing into a unified process. This may have several advantages. While installing a product, the customer registers it. This automatically enables the customer to use the DNS/Naming registration service offered by the company, which automatically assigns a customer specified symbolic name for the product so that it can easily be found on the Internet. If the product is running on a computer with a dynamic IP address, the company can also provide dynamic DNS resolution services. Creating a DNS name for the product can be done simply and inexpensively by utilizing one of the domains owned by the company, and allowing the customer to choose a subdomain of this. This subdomain will be assigned to the customer, yet it is still ultimately controlled by the company. Once this happens, it is very easy to create and sign a SSL certificate based on this subdomain. A significant cost in signing a SSL certificate is in verifying that the domain is really owned and controlled by the entity presenting a certificate for signing. In this case, no such verification is required, since the domain was just assigned and the company knows to whom it was assigned.

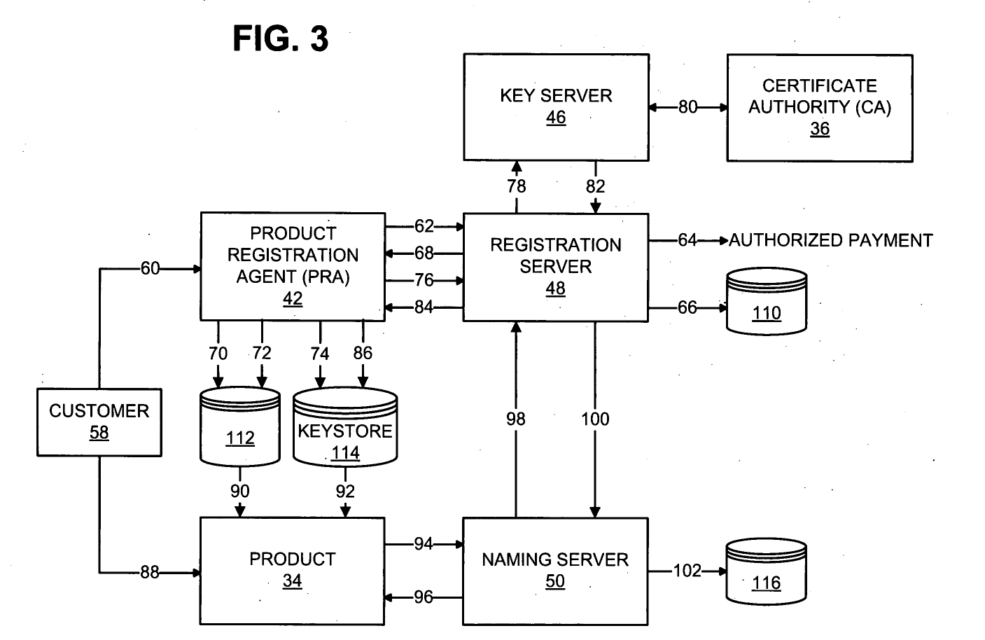

Furthermore, product registration for DNS/Naming and certificate signing purposes may happen at any time during the product's lifecycle. The example discussed below with reference to FIG. 3 shows the process happening during installation, but it can also happen later.

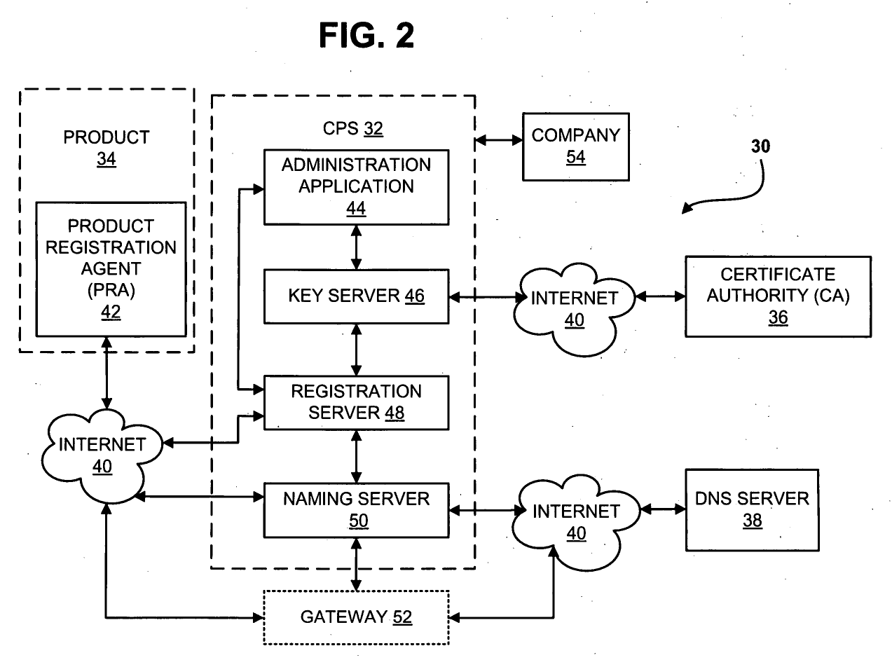

Referring now to FIG. 2, a block diagram of a system utilizing an embodiment of the present invention is shown generally as 30. System 30 comprises a Certificate Provisioning Server (CPS) 32, a product 34, a Certificate Authority (CA) 36, a DNS server 38 and a network 40. In the embodiment shown network 40 is the Internet. To simplify the drawing, network 40 has been replicated for understandability, but it is in reality a single network.

CPS 32 is utilized by a company 54 for the purpose of securing a product 34 that it develops. Product 34 is a software or hardware application produced by the company 54 that enables a computer or device connected to network 40 to share data with other computers on the network. Alternatively, product 34 may be a software or hardware component that performs security functions and can be embedded into another product (such as a standard web server or a hardware device). Examples of such products would include: web servers, file sharing systems (peer-to-peer (P2P) or otherwise), remote computer control applications, Internet hardware devices, network attached storage (NAS) devices that allow the serving of data across network 40, and cell phones and PDAs, if they are equipped with a mass storage device and software to allow them to share its contents.

Certificate Authority (CA) 36 is a company that is known to be trusted, and performs the service of processing and signing CSRs. The CA's root certificate is known to many browsers that are deployed across the Internet. Alternatively the CA could be company 54 itself, using a root certificate that it created and owns.

DNS server 38 is a Domain Name Server, which resolves domain names to IP addresses. This server should have a well-documented interface so that an external process may add, delete, and modify domain name records. This interface should operate as a Web Service or otherwise well defined process.

Product 34 further comprises a Product Registration Agent (PRA) 42. PRA 42 works in conjunction with product 34 during product installation to allow customers to register product 34 with the company 54 through the use of certificate provisioning server (CPS) 32.

CPS 32 consists of a set of applications that are controlled by a company 54, namely: an administration application 44, a key server 46, a registration server 48, and a naming server 50. They may run on independent servers not on the premises of the company 54 and be connected to each other via network 40. Administration application 44 is an application that can run to view and control the status of system 30. This application may be used for functions such as revocation of certificates. Key server 46 processes Certificate Signing Requests (CSRs) from PRAs 42 (by way of a registration server 48). Key server 46 may interact with a known CA 36 to process CSRs, or may process them itself if possible. Key server 46 accepts CSRs as PKCS #10 Certificate Signing Requests and produces PKCS #7 Formatted Certificate Chains (FCCs). Any similar standard formats may also be supported as required. Registration server 48 accepts requests from PRA 42, and processes them on its behalf. Naming server 50 stores the current IP addresses of all running products 34 and allows them to connect to it so that they can register their current IP address. Naming server 50 provides information to gateway server 52 and DNS Server 38 on the names and current addresses of products 34 so that users who want to connect to a product 34 can find it. Gateway server 52 is optional and when in use can concurrently service many running products 34, and may perform duties such as helping with security, discovery, or connectivity. When used, gateway server 52 sits between product 34 and a user attempting to access content from product 34. As such, it acts as a reverse proxy server. A gateway server 52 may be used to avoid the need to open a port on a firewall protecting product 34 and thus provides an extra level of security.

Referring now to FIG. 3, a block diagram illustrating the logical interaction between the modules of the system of FIG. 2 is shown. Beginning with step 60 the purchaser of the product (a customer 58) chooses to enable the security/privacy features of the product and run PRA 42 either while installing the product or afterward. In one embodiment PRA 42 is embedded in the product but it may also be a standalone process. At this step the customer enters the following information into PRA 42:
a) Basic customer information (e.g. name, address, e-mail, etc.).
b) Payment information. Note that these steps are written as if the customer is installing and paying for the product at this point. In contrast, if the product is already paid for, then this information is omitted. Instead, customer authentication information that was created upon payment is included here.
c) Server identifier, chosen by the customer. It is used to create the DNS subdomain and is unique across all servers that are using the same base domain. It is easily identified with the customer, for example, the customer's name.
d) Server Password, chosen by the customer.

At step 62 PRA 42 transmits the following information to registration server 48:
a) Basic customer information
b) Payment information
c) Server identifier
d) SPhash, this is the server password encrypted with a one way hash function, such as message digest five (MD5). This is done so that the real password never needs to be transmitted from the customer's computer, but the hashed version may be checked to see if it was entered correctly. A random number that is stored in the product's database 112 could be incorporated into the calculation of SPhash to discourage dictionary attacks for guessing the password.

Registration server 48 upon receiving the information from PRA 42 performs the following checks:
a) The basic customer information correlates with the payment information.
b) Payment is authorized (or the product has been authenticated), via step 64.
c) That the server identifier is unique across all of the servers managed for this domain.
d) Other checks as directed by the company 54, such as that the server identifier does not contain a vulgar word.
If any of these checks fail, registration server 48 returns information to PRA 42 to advise the customer 58 of the problem. The customer 58 then repeats step 60.

At step 66 registration server 48 stores the following information in database 110: the basic customer information, the server identifier, SPhash, the registration date, and the expiration date. The expiration date is calculated as the registration date plus the registration period as defined by the company 54.

At step 68 registration server 48 returns information to PRA 42 to advise the customer that registration was successful. This information includes: the registration date and the expiration date.

At step 70 PRA 42 stores the server password in product database 112. At step 72 PRA 42 stores the server identifier in product database 112. PRA 42 then generates a public/private key pair and creates an X.509 certificate. This certificate has the following characteristics:
a) Subject common name. This is the DNS name of the server. This is calculated by prepending the server identifier onto a fixed domain name owned by the company 54. Alternatively, if a non-DNS system is used for discovery (such as a P2P system) this name corresponds to the needs of that system, such as a simple server name.
b) Valid from date. This is the registration date.
c) Valid to date. This is the expiration date.
Any mechanism similar to X.509 that can be used to create a binding between entity identities and public keys may be used as long as that mechanism also allows for the creation of SSL sessions.

At step 74 PRA 42 then stores this certificate (as well as the private key) in a product keystore database 114 using the server password as the password for the keystore database 114. A separate password can also be used for this purpose, but then the customer would need to remember several passwords. PRA 42 then generates a standard PKCS#10 CSR from the certificate. A similar format that serves the same purpose as a PKCS#10 CSR can also be used for this purpose.

At step 76 PRA 42 transmits the following to registration server 48 in a secure manner:
a) the CSR;
b) the server identifier; and
c) SPhash
Upon receipt, registration server 48 checks to ensure that the server identifier and SPhash are correct.

An optional step (not shown) involves a vetting process. The vetting process is optional at this point and is at the discretion of the company 54 and/or the CA, if one is involved. In general, the purpose of the vetting process is to validate the claim that the owner of a private key also has legal authority over a domain name. However, since agents of the company 54 create both the private key as well as assigned the domain name, it is not really required. Since the connection between the private key and the domain name is inherently established, no one must prove the connection between the two. Vetting may be required at this stage to validate the customer's identity. Since the customer has purchased the product, there is already a relationship between the customer and the company 54. The customer can be automatically validated as follows:
a) If the customer pays by credit card, verifying that the person using the credit card is legitimate and that the credit card is not stolen. To help ensure this, the customer can be prompted for additional information, such as the credit card's security numbers.
b) Insistence that registered e-mail addresses cannot come from free and untraceable sources such as Hotmail or Yahoo Mail.
c) A client or e-mail certificate can be used to identify the customer.
d) A phone number may be used to help identify the customer by either having the customer call an automated service (and using caller-ID to verify the phone number) or having the customer enter an available phone number and automatically calling to verify. In either case, the intent is to verify that the person at the phone number provided is the customer installing the product. Following that, PRA 42 can display a random secret number that the customer must enter at the end of the phone call on his phone keypad. This number is known to registration server 48 (and hence the service that is on the line with the customer) and can be transmitted to PRA 42 for verification.
e) If the product (or a license for it) is sold in a retail store, then vetting can happen either by checking a credit card or a driver's license when it is purchased. Information about the license number and the customer's identification can be gathered then and transmitted to the company 54.

If extended vetting is required, then it can be offline and non-automatic, such as faxing or otherwise sending copies of legal documents. The rules for vetting a customer are as strict or as lax as the company 54 chooses. Vetting is not really required, since there is nothing to be gained by trying to impersonate another person using a stolen credit card and e-mail address. When this is discovered, the company 54 easily and immediately terminates that customer's registration of the product installation, denies DNS resolution, and invalidates the SSL certificate. This renders useless any mistakenly issued certificates. In an e-commerce environment, it is crucial to verify the binding of the private key with an entity such as a real person, corporation, or government agency. However, embodiments of the present invention need only to verify the binding of a private key with a running product. Because of this, the vetting process can be much simpler. Once a customer is sufficiently vetted, PRA 42 is notified, and the process continues with SSL certificate provisioning beginning at step 78.

At step 78 registration server 48 transmits the following to key server 46:
a) the Certificate Signing Request (CSR);
b) the server identifier; and
c) the registration and expiration dates, from database 110.
Key server 46 then checks this information to verify that the subject's common name is correct for this server identifier. The CSR is now accepted, and a certificate is signed by the issuer. If key server 46 serves as the issuer (e.g. it has a valid certificate to sign with) then it signs the certificate. Otherwise, a well-recognized CA 36 with which the company 54 has a relationship is the issuer. In this case, key server 46 transmits the necessary information to CA 36 to sign the certificate at step 80. Different CAs may require different information to do this. The issuer then creates a PKCS#7 Formatted Certificate Chain based on the information received in the request, and signs it with its certificate. In creating, this certificate chain, the issuer signs the product's certificate and adds itself as the issuer. A similar file that serves the same purpose as a PKCS#7 FCC can also be used for this purpose.

At step 82 the FCC is transmitted back to registration server 48. At step 84 registration server 48 transmits the FCC back to PRA 42. At step 86 PRA 42 stores the FCC into keystore database 114. This certificate is used to complete SSL connections to the clients that the product services.

At this point the registration of the product is now complete, and PRA 42 is no longer necessary. The product now has enough information to start up and run. At step 88 customer 58 starts to run the product 34. At step 90 product 34 reads the server password from product database 112. At step 92 product 34 reads the private key and the corresponding certificate from keystore database 114 using the server password as the keystore password. If a different password was used, the customer is prompted for it. Product 34 is now ready to allow clients to connect to it securely by providing this certificate during the SSL handshake. Product 34 periodically verifies that its certificate is still valid. For instance, the certificate expires once the expiration date has passed. When this happens (or sometime before), product 34 notifies the customer 58 who can then take action so that product 34 continues to run properly. This may mean running PRA 42 again (or running similar functionality within product 34) that goes through the same steps as were taken during product registration to request, pay for, receive, and install a valid certificate. Processing then moves to step 94 to initiate the naming update process.

If the computer hosting product 34 has a static IP address, then the naming update process needs to happen only once. Otherwise, it runs periodically, in case the IP address changes. At step 94 product 34 transmits the following to naming server 50:
a) The server identifier.
b) SPhash.
c) Connection method. We discuss the two types of connection methods, direct connection and gateway connection, below. If the company 54 offers both these choices, the customer decides which method to use.

Naming server 50 obtains the IP address of product 34 from the TCP/IP header. It then checks whether or not the IP address has changed since it was last contacted by this server. If the IP address has not changed, then naming server 50 returns an “OK” message to product 34 at step 96. Otherwise, naming server 50 transmits the server identifier/SPhash to registration server 48 at step 98. Registration server 48 validates the server identifier/SPhash and returns the information to naming server 50 at step 100. If successful naming server 50 updates its database of name mappings 116 with the new IP address at step 102. Naming server then replies via step 96 with an “OK” message to product 34.

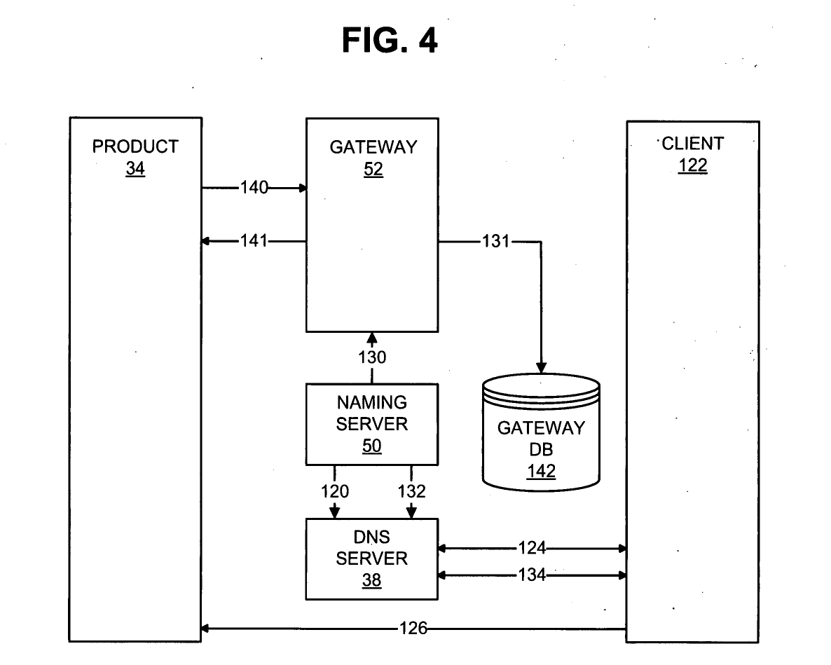

Referring now to FIG. 4, a block diagram illustrating the steps in connecting a client and a product is shown. At this point product 34 has been registered and a SSL certificate issued. Product 34 is now running and available for connections from clients. By way of example, in the embodiment shown in FIG. 4, product 34 is like a web server, and browsers that enter a known web site address can connect to it. For example, say the company 54 owns the domain mycompany.com and the product identifier of a certain product installation is RemoteServer, then browsers may find this remote access server at RemoteServer.mycompany.com. In an embodiment of the present invention, a client does not need to know whether a gateway is involved in the connection or not, and in fact, product 34 may work with or without the gateway depending on its requirements. Depending how the product is configured, either a direct connection or a gateway connection method is used. While both connection methods are described here, product 34 must be configured for one method or the other.

In the direct connection case, when the naming server 50 is updated with a new IP address for a product 34, it contacts DNS server 38 responsible for mycompany.com and at step 120 creates or updates the DNS record for RemoteServer to point to the appropriate IP address. A user of a client 122 when navigating to RemoteServer.mycompany.com causes DNS server 38 to resolve the domain name RemoteServer.mycompany.com to the IP address of the computer running product 34. This resolution occurs at step 124. Client 122 can now connect directly to product 34 as shown in step 126. SSL is possible because the product has a valid certificate for RemoteServer.mycompany.com. In one example client 122 would be a web browser and product 34 would be a web server.

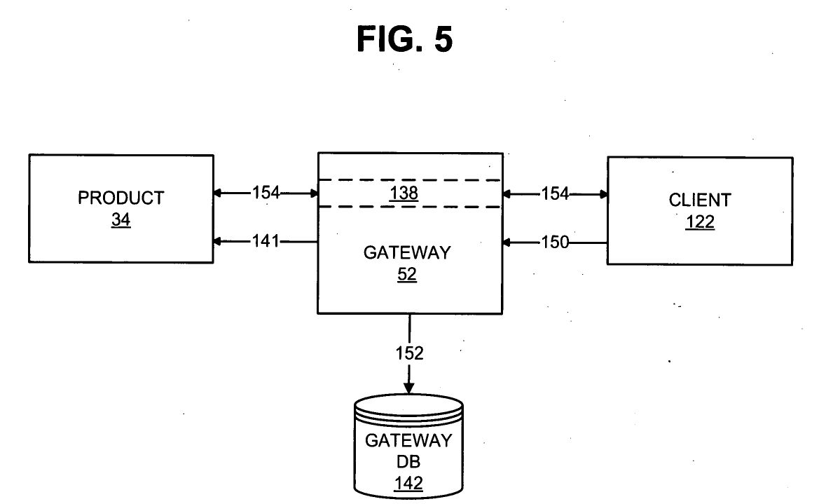

In the gateway connection case, when naming server 50 is updated with a new IP address for product 34, it contacts gateway 52 at step 130 and informs it that RemoteServer is at a given IP address. This address is then stored by gateway 52 in gateway database 142 at step 131. Next at step 132 naming server 50 contacts the DNS server 38 responsible for mycompany.com, and it creates or updates the DNS record for RemoteServer.mycompany.com to point to the IP address of gateway 52. This way, naming server 50 can service products that accept connections with either the direct or gateway connection method. At step 134 the use of a client 122 to access RemoteServer.mycompany.com resolves to the IP address of gateway 52 which is utilized by embodiments described in FIGS. 5, 6 and 7. Step 140 is run periodically so that product 34 may determine if there are any pending connections. When there is a pending connection, gateway 52 can then act as an intermediary between product 34 and client 122. At step 141, gateway 52 responds to product 34 concerning whether or not there is a pending connection. If there is none, gateway 52 replies this, otherwise it takes actions based on the connection method as described in embodiments illustrated in FIGS. 5, 6 and 7.

We will now describe three methods for obtaining a gateway connection between client 122 and product 34 through gateway 52. To describe these methods we refer to FIGS. 5, 6 and 7.

FIG. 5 is a block diagram illustrating a process of connecting a client and a product through a gateway. As indicated by feature 150, the user of client 122 selects the URL of product 34, and specifies SSL to be used. Gateway 52 will be contacted due to the resolution done in step 134 of FIG. 4. Gateway 52 does not immediately respond to this request, but rather leaves the connection open. At step 152 gateway 52 then determines that the request is destined for product 34 and looks up the location of product 34 in gateway database 142. Gateway 52 then responds to product 34 in step 141, and uses this connection, as well as the previously open connection 150 to client 122 to create a tunnel 138 to allow the flow of SSL traffic. Product 34 now may reply to request from client 122 via path 154 through tunnel 138.

The step of gateway 52 determining the destination for request 150 is problematic if SSL is being used. This is because gateway 52 cannot determine what the original request was using standard methods, it only knows that it was connected. To get the original request gateway 52 examines the HTTP HOST: header which indicates which product the request is bound for. However, this cannot be done without first going through an SSL handshake to set up the SSL link that must be created. The handshake cannot occur without first determining which product is requested as the product is the only server having a valid certificate for the requested domain. This problem is resolved if client 122 uses Transport Layer Security (TLS) v1.1. TLS v1.1 allows a client to pass an identifier for the domain name that it wished to connect to in an extended ClientHello message as defined in RFC 3546. If this protocol is not being used, then an alternate method described below may be used to determine the destination.

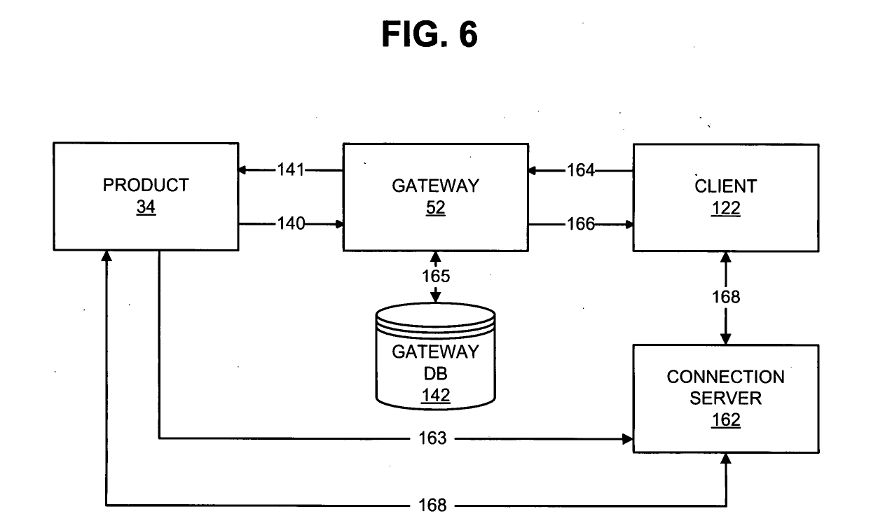

FIG. 6 is a block diagram illustrating a process of connecting a client and a product through redirection. At step 141 gateway 52 informs product 34 of the address of a connection server 162 to connect to and a port on the connection server 162 to use and stores this information in gateway database 142. Step 141 occurs when a request for pending connections is received via step 140 from product 34. This is the same step 140 of FIG. 4. At step 163, product 34 performs reverse port forwarding to connection server 162, to forward its port to the port on connection server 162 as directed by gateway 52. At step 164 a user browses to gateway 52 using standard HTTP in an attempt to connect to product 34. This is due to the resolution of step 134 of FIG. 4. At step 165 gateway 52 determines that the request to connect is destined for product 34 by examining the HOST header and the information stored in gateway database 142. At step 166 gateway 52 then redirects client 122 to the correct URL for accessing product 34 through connection server 162 via path 168. This connection may be secure since product 34 has a SSL certificate. Client 122 is now free to interact with product 34 through connection server 162 along path 168. The purpose of connection server 162 is simply to create a place where products 34 can set up reverse port forwarding. In practice, connection server 162 may be a Secure Shell (SSH) server. Although shown as two separate features, gateway 52 and connection server 162 may be run on the same computer.

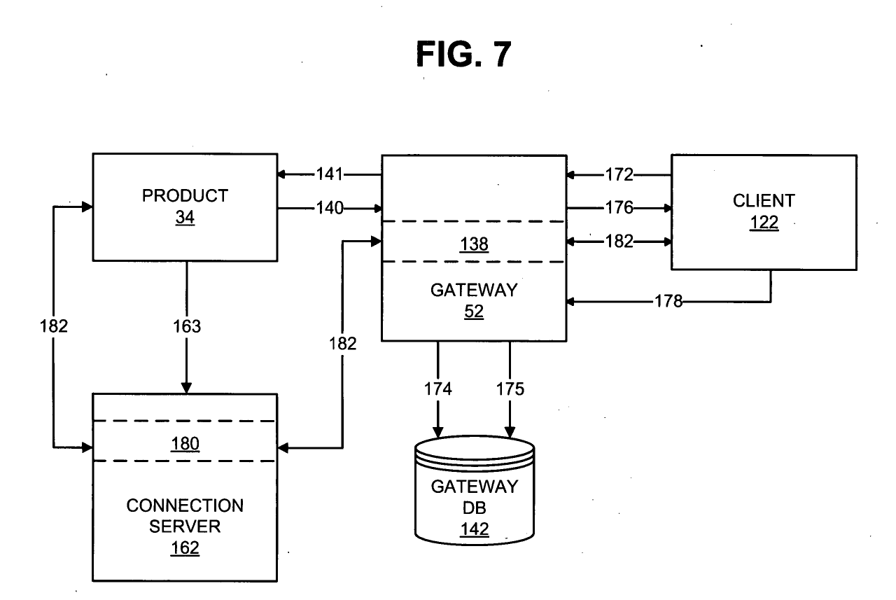

FIG. 7 is a block diagram illustrating a process of connecting a client and a product through predictive demultiplexing. At step 141 gateway 52 informs product 34 of the address of a connection server 162 to connect to and a port on the connection server 162 to use and stores this information in gateway database 142 at step 174. Step 141 occurs when a request for pending connections is received via step 140 from product 34. This is the same step 140 of FIG. 4. Next is step 163 as previously described with reference to FIG. 6. At step 172 a user browses to gateway 52 in an attempt to connect to product 34 using standard HTTP. Gateway 52 is contacted due to the resolution of step 134 as described with regard to FIG. 4. Gateway 52 determines that the request to connect is destined for product 34. This is achieved by gateway 52 examining the HOST field in the HTTP header of the request. Gateway 52 then determines information about client 122, specifically the IP address of client 122 and stores the information in gateway database 142 at step 175. At step 176 gateway 52 sends a redirect to client 122 to go to a URL having a HTTPS prefix to use SSL. This will cause a new request to gateway 52 but on a different port. At step 178 client 122 now accesses the HTTPS address. Gateway 52 accepts this request on its SSL port. Gateway 52 cannot go through an SSL handshake at this point as it does not have a valid certificate for the domain, and hence it cannot look at the request. However, it does have the IP address of the requesting client 122 stored in database 142. Gateway 52 then uses the IP address to determine that client 122 wishes to access product 34. If gateway 52 senses that things are going wrong, for instance if gateway 52 cannot find the IP address in gateway database 142, it can return an error to client 122 and force it to go through the second connection method described above with reference to FIG. 6. Gateway 52 then looks up the identity of a connection server 162 servicing the domain of product 34 and a port on the connection server to connect to from the information stored in gateway database 142. Gateway 52 then builds tunnels 138 and 180 between connection server 162 and client 122 to allow the flow of SSL traffic. Client 122 is now virtually connected with SSL to product 34 through both tunnel 138 and tunnel 180 by a reverse port forwarding to connection server 162. Product 34 may now reply to requests from client 122, through path 182.

We will now address the issue of certificate revocation. In embodiments of the present invention, it is very easy to make a certificate unusable. A certificate is bound to a name that the company 54 ultimately controls via naming server 50 in conjunction with DNS server 38. To revoke a certificate, the company 54 simply denies resolution to that name. If the name in that certificate cannot be resolved, the certificate becomes useless. In revoking a certificate, an embodiment of the present invention utilizes the following features:
a) If DNS is used, then the Time-to-Live (TTL) value, defined in the DNS mapping in DNS server 38, is set very low so that it is not cached by other servers. This enables certificate revocation to happen in a timely fashion.
b) DNS is not a secure process. It is possible for an Internet Service Provider (ISP), or any computer between a client and DNS server 38 to modify the results of DNS resolution. Therefore, it is unwise to rely solely on cutting off DNS resolution to revoke a certificate, and issuing a CRL is an important backup step.
c) Registration server 48 periodically looks through the registered product list to find products 34 whose registration has expired. When this happens, registration server 48 contacts naming server 50 to request it to discontinue DNS resolution for that product.

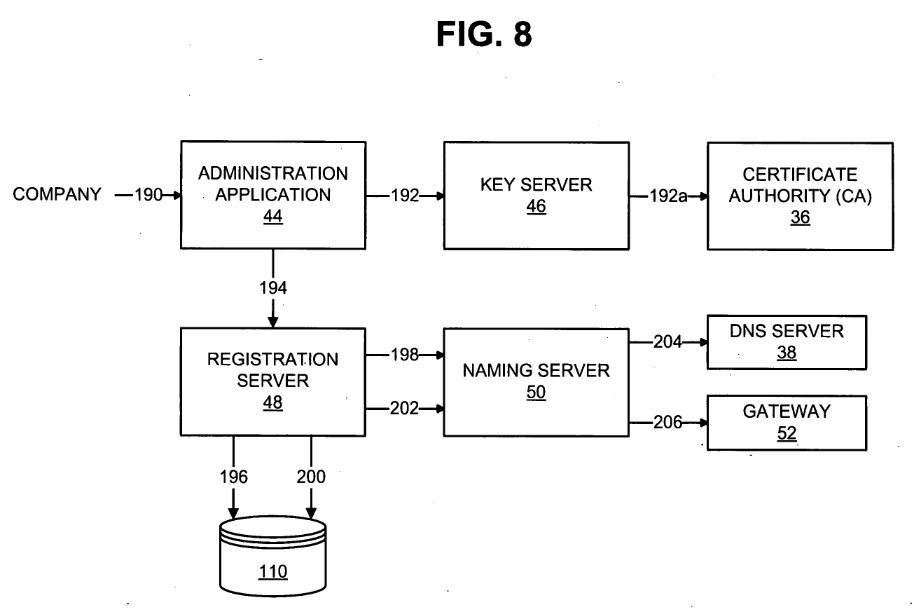

Referring now to FIG. 8, a block diagram illustrating the steps in revoking a certificate is shown. Beginning at step 190 the customer and/or the company 54 realize that a certificate has become compromised and want to revoke it. The company 54 is notified. An agent of the company 54 uses administration application 44 to select the proper server ID to revoke. At step 192 administration application 44 informs key server 46 of the change. If key server 46 was the issuer of the affected certificate, then it issues a CRL. Otherwise, it interacts with certificate authority 36 via step 192a that was the issuer to request it to issue a CRL. At step 194 administration application 44 notifies registration server 48 of the intention to revoke a server ID's certificate. At step 196 registration server updates database 110 with the revocation information. At step 198 registration server 48 notifies naming server 50 of the intention to revoke a server ID's certificate. Naming server 50 can now go through the name resolution cutoff process, described below beginning with step 204.

In dealing with expired certificates, registration server 48 periodically searches through database 110 for certificates that have expired. In this case, it is unnecessary to issue a. CRL; cutting off name resolution is all that is required. At step 200 registration server updates database 110 with the expiration information. Once registration server 48 has a list of names to which to deny resolution, it transmits these to naming server 50 at step 202. Naming server 50 can now go through the name resolution cut off process, described below beginning with step 204.

With regard to name resolution cut off, processing begins at step 204 where naming server 50 informs DNS server 38 to stop resolving the relevant name. DNS server 38 removes this name from its list of known names and any requests to resolve it fail. This change may need to propagate through the Internet for a short time. If the gateway connection method is used, naming server 50 instructs gateway 52 at step 206 to stop resolution for the name, and gateway 52 immediately updates its information and refuses to resolve that name.

As certificates eventually expire, it is helpful to be able to easily extend the usable lifetime of a product 34. However, changing any data in a certificate invalidates the entire certificate, since it must be signed. Therefore, a new certificate is required. Product 34 can notify the customer about when its license will expire. When this happens, the customer can use PRA 42, or similar functionality in product 34, to re-register product 34 to extend its life. Any information originally entered when a product 34 was first registered, and stored by registration server 48 (such as the customer's basic information) does not need to be re-entered. However, the entire process is repeated to generate, sign, and install a new certificate.

In some cases a customer may not wish to store a server password. Storing the server password on the computer that uses it is clearly a security issue. This situation can be avoided by not storing the password in product database 112, and instead prompting the customer for the password every time product 34 starts. While this increases security, it prevents product 34 from starting until the customer takes some action, and it precludes product 34 from starting automatically when the computer boots. If the password is stored in the database, it may be encrypted. In one embodiment, the customer can configure whether or not to store the password in product database 112.

In some cases a customer may wish to have an independent domain name. While the intent of embodiments of the present invention is to allow customers to automatically create and configure SSL certificates for registered subdomains so that their products can be found more easily on the Internet, the same system can also be used when registering an independent domain on the Internet. In an alternative embodiment a customer may register, install, and configure a SSL certificate for their web server (or similar software) quickly and easily without much know how. If a customer uses an independent domain name, the process with regard to the description of FIG. 3 changes as follows.

At step 60 instead of entering the server identifier into the PRA, the customer enters the domain name to register and use. From then on, whenever the server identifier is required in the process, the domain name is used instead. At step 64 when registration server 48 attempts to authorize the customer's payment, if possible, it also registers the customer's domain using any required external process. If this process fails, then this information is returned to the customer using PRA 42 at step 68. Otherwise, the process runs normally. Depending on the external process used to register a domain, additional information may be required from the customer. When creating the X.509 certificate, PRA 42 uses the domain it registered as the subject/common name. When checking this, registration server 48 takes this into account.

In the case of certificates created for independent domains instead of subdomains they cannot be revoked by cutting off DNS resolution because the company 54 does not necessarily control the DNS server that resolves the domain. Normal certificate revocation must be used instead.

Another option for declaring ownership in the generated X.509 certificate is to use the IP address on which product 34 is running. If the IP address changes dynamically the system will fail (at least temporarily). However, if product 34 checks its own IP address on a regular basis, it can detect this situation and take the necessary actions to fix it. In order for this system to work, the process described with regard to FIG. 3 changes as follows.

PRA 42 and product 34 determine the IP address of the computer on which they are running. There are many ways to do this, for example:
a) If the computer is directly connected to the Internet, a simple query may determine the IP address.
b) If the computer is running behind a router that is Universal Plug and Play (UPnP) enabled (or any similar protocol), then that device may be queried to determine the IP address
c) If no facilities are available, then a server may be set up at a publicly accessible location on the Internet that accepts external Hypertext Transfer Protocol (HTTP) requests, and returns the IP address of the requesting client, by reading the requesting IP header. When creating the X.509 certificate, PRA 42 determines the IP address on which it is running. This is in the SubjAltName/IPAddress field. While this is unusual, it is within the HTTP Secure Sockets (HTTPS) specification (RFC 2818) and works properly with browsers. When registration server 48 receives the CSR at step 76, it determines the IP address of the sender from the IP header and sends this to key server 46 at step 78 for verification. Since there is no DNS component, these types of certificates are difficult to revoke. Therefore, the certificates should be valid for as short a period as practically possible. Upon receiving and using a signed certificate of this type, product 34 queries its own IP address frequently to verify that the certificate is still valid. If the IP address changes, then the certificate is no longer valid. Product 34 then discards the invalid certificate and generates (and has signed) a new one in the same way that PRA 42 did the original one.

In another embodiment of the present invention it is possible to complete the entire registration in one step. In the embodiment described with regard to FIG. 3, PRA 42 made two requests of registration server 48, one at step 62 and another at step 76. In this embodiment registration server 48 can be sure that the second request came from PRA 42 and not elsewhere because the links are secure and the second request comes with an identifier/password. However, if the company 54 wants, it can configure registration server 48 to set up a session with PRA 42 when it receives the first request. This session may be created by means of a cookie or a unique identifier that is included in the URLs of I subsequent requests. In order to be valid, the second request must come from the same session as the first.

To complete the entire registration in a single request requires the generation and sending of a CSR along with all the data needed in the first request. Note that while a single request is more efficient, two requests are more flexible for the following reasons:
a) With two requests, PRA 42 knows the exact times when the certificate is valid. A single request requires the PRA to estimate these values.
b) Two requests allow for the possibility of a vetting process. While it is not really necessary to run such a process, the company 54 can do so if it chooses.

In some embodiments of the present invention, a certificate is created, signed, and installed as a part of the product deployment. As long as the certificate is used in conjunction with the product, it is not intended to be used for e-commerce. However, the certificate is still a valid certificate, and there may be concerns that it could be used for other purposes. This can happen if the customer can obtain the certificate and the private key created exclusively for the customer's product and install them elsewhere. Even though the customer can use this certificate only with the assigned subdomain (since that information is embedded in the certificate), it is still a valid concern. For instance, a customer who accesses the private key could use it to SSL enable any web server, which could run an e-commerce site. In this scenario, a customer would have a valid SSL certificate for e-commerce. While a certificate created by the present invention and those used in e-commerce are similar there is one significant difference. In an e-commerce situation, the base domain is controlled by the entity that owns the certificate; in the present invention, the base domain is owned by the company 54, which allows the customer access only to the subdomain that it creates in order to run the product. This means that if the customer misuses the certificate signed exclusively for that customer, the company 54 can easily render this certificate inoperable. While the company 54 can do this with a CRL, it can do it most effectively by stopping the DNS resolution. While it is possible to stop DNS resolution to sites controlled by the certificates of embodiments of the present invention, it is not possible in the typical e-commerce environment. Although embodiments of the present invention are discussed with relevance to the creation of certificates that are not traditionally associated with e-commerce applications, embodiments of the present invention may also be implemented in an e-commerce environment should the e-commerce vendor wish to provide subdomains for products.

There are additional methods for discouraging people from using the certificates of embodiments of the present invention for unintended purposes. Any, all, or any combination of the following five methods may be used.
1) Writing information into the certificate. The certificates can be modified to discourage their use for unauthorized purposes. For example, a message such as the following can be written into certificate fields, which are viewable by anyone looking at them: “While this site is protected by SSL, it is not authorized for e-commerce. If this is an e-commerce site, please contact . . . ”. A similar statement can also be added to the Certificate Practice Statement (CPS) under which the certificate is issued. The likelihood of being discovered and being shut down will discourage unscrupulous customers from trying to cheat the system.
2) Encrypting the private key. Encrypting the private key deters people from extracting it to use it elsewhere. Encryption is not a panacea, as there clearly must be a way for the product to decrypt this key without information from the customer. However, the information necessary to decrypt this key can be hidden inside the product, or can be obtained from a server controlled by the company 54 and available on the Internet. Even if this is done, a customer with sufficient knowledge can reverse engineer the process to extract the private key. Therefore, while this encryption is not completely secure, it will slow down those who want to reuse the private key.
3) Modifying the domain name. As the company 54 controls the format of the domain name it can assign a subdomain that is clearly not to be used for e-commerce purposes, for example: RemoteServer.no_e-commerce.mycompany.com. This informs anyone who browses to this site that it is not an e-commerce site.
4) Checking running servers. The company 54 can easily check the servers running at the subdomain and verify that the product is running there, and not an unauthorized application. If the company 54 discovers that the certificate is used for an unauthorized purpose, it can disable the subdomain and certificate.
5) A field may be added to the certificate that indicates this certificate is not for e-commerce usage. Browser manufacturers would then be free to add a new icon, or perhaps modify the current SSL mode icon to indicate to the user that SSL mode is being used, but it is not intended for e-commerce usage.

A digital watermark may be added to all the files served by the product, for example by means of steganography. This would add identifying information to a file requested by a user to identify the user. If the product requires a user to sign in, the identifying information would be the userid. Alternatively the identifying information could be the date of the request and the IP address of where the request originated.

Examples of embodiments of the present invention have been directed to a company 54 that is responsible for a product that controls only one side of a transmission. An example of this is the product it develops which serves as a web server and the client is a browser that is developed by someone else. In a second embodiment the company 54 is responsible for the products on both sides of the transmission. An example of this would be a Peer-to-Peer (P2P) system where a single program may act as both a client and a server. In this second embodiment the present invention may also be utilized. The second embodiment may utilize DNS but it is not required. If the company 54 wishes, it may develop its own system so that one product may find another. Under such a system, revocation simply means not finding a server. Normally, the subject's common name in a certificate contains the name of the domain being protected. However in the case where both ends of a connection are controlled by the company 54 any information may be stored in this field. Embodiments of the present invention will work for any protocol that is based upon TCP.

Embodiments of the present invention have been shown by way of example to utilize server based SSL certificates. There is a provision in the SSL handshake process for a client to authenticate itself to a server using a client certificate. A client certificate is identical to a server certificate except that the subject name is different. Most commonly the subject name would be a person's name or their email address. Embodiments of the present invention may be utilized in the same manner as described above to provision client certificates.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

I claim:

1. A system for the automated issuance of a SSL certificate, said system comprising:
a first product operatively connected to a product registration agent;
a certificate provisioning server operatively connected to said product registration agent under control of an entity; and
said certificate provisioning server operatively connected to a certificate authority and a domain name server.

2. The system of claim 1 wherein said certificate provisioning server comprises an administration application, a key server, a registration server, and a naming server.

3. The system of claim 1 further comprising means for providing a subdomain associated with said first product, to permit a client to connect to said first product via said subdomain, said subdomain under the control of said entity.

4. The system of claim 1 further comprising a gateway operatively connected to said first product and a client.

5. The system of claim 1 further comprising means for revoking said SSL certificate if said SSL certificate has been compromised or expired.

6. The system of claim 1 further comprising means to allow a customer to specify an independent domain to permit a client to connect to said first product.

7. The system of claim 1 further comprising a second product acting as a client connected to said first product under the control of said entity.

8. The system of claim 1 wherein said SSL certificate may be a client certificate or a server certificate.

9. The system of claim 1 further comprising a connection server connecting said first product to a client.

10. The system of claim 1 further comprising means for preventing the use of said SSL certificate for e-commerce.

11. The system of claim 1 further comprising means for connecting said first product to a client via a direct connection or a gateway connection.

12. A method for the automated issuance of a SSL certificate, said method comprising the steps of:
installing a first product;
invoking a product registration agent to generate a CSR, the DNS name within said CSR being known to said product registration agent;
forwarding said CSR to a certificate authority for issuance of said SSL certificate; and
returning said SSL certificate to said first product to permit secure communication between said first product and a client.

13. The method of claim 12 further comprising the step of providing a subdomain associated with said first product, to permit said client to connect to said first product via said subdomain, said subdomain under the control of said entity.

14. The method of claim 12 further comprising the step of allowing said client to connect to said first product via a direct connection or a gateway connection.

15. The method of claim 12 further comprising the step of revoking said SSL certificate if said SSL certificate has been compromised or expired.

16. The method of claim 12 further comprising the step of permitting a customer to specify an independent domain to permit a client to connect to said first product.

17. The method of claim 12 further comprising the step of providing a second product acting as a client to connect to said first product under the control of said entity.

18. The method of claim 12 wherein said SSL certificate may be a client certificate or a server certificate.

19. The method of claim 12 further comprising the step of utilizing a connection server to connect said first product with said client.

20. The method of claim 12 further comprising the step of preventing the use of said SSL certificates for e-commerce.

21. A computer readable medium comprising instructions to execute the method of claim 12.
